(19) United States
(12) Patent Application Publication
(10) Pub. No.: US 2005/0000470 A1
(43) Pub. Date: Jan. 6, 2005

(54) Leash

(76) Inventor: Tzanis Fountoulakis, Bad Salzuflen (DE)

Correspondence Address: LERNER AND GREENBERG, PA, P O BOX 2480, HOLLYWOOD, FL, 33022-2480, US

(21) Appl. No.: 10/898,049

(22) Filed: Jul. 20, 2004

Related U.S. Application Data
(63) Continuation of application No. PCT/DE03/00159, filed on Jan. 21, 2003.

(30) Foreign Application Priority Data
Jan. 21, 2002 (DE) 202 03 731.2

(51) Int. Cl. A01K 27/00

(52) U.S. Cl. 119/769

(57) ABSTRACT

A significantly improved leash has a strap or belt with a carabiner at a lower end and a loop at an upper end. The loop may be a preconfigured holding loop or it may be an adjustable loop that can be adjusted by clipping a carabiner into eyelets in the leash. The leash permits even an animal that is pulling strongly on the leash to be held in check, by a hand grip disposed in the holding loop, or adjacent to the holding loop.

### CROSS-REFERENCE TO RELATED APPLICATION

This application is a continuation, under 35 U.S.C. § 120, of copending international application No. PCT/DE03/00159, filed Jan. 21, 2003, which designated the United States; this application also claims the priority, under 35 U.S.C. § 119, of German patent application No. 202 03 731.2, filed Jan. 21, 2002; the prior applications are herewith incorporated by reference in their entirety.

### BACKGROUND OF THE INVENTION

### FIELD OF THE INVENTION

The invention relates to leashes, or leads, of the type having a strap or belt and a carabiner hook or snap hook at a bottom end, for attaching to an animal's collar or harness. The strap or belt further has a retaining loop at a top end. The loop is either fixed or it can be adjusted by engaging a carabiner hook or a snap hook in eyelets disposed along the leash.

Prior art short or long leashes can be used to leash animals, in particular dogs, with a greater or lesser clearance. Such known leashes usually have, at their ends, retaining loops which make it possible to control an animal that pulls strongly on the leash. In many cases, such retaining loops nevertheless do not provide a firm grip for a hand holding the leash, with the result that it is possible that a thin leash cannot be reliably secured in every position and for an animal to break away together with the leash. Furthermore, these known leashes cannot be utilized, at any rate without further accessories, for reliably transporting animals in motor vehicles.

### SUMMARY OF THE INVENTION

It is accordingly an object of the invention to provide an improved leash, which overcomes the above-mentioned disadvantages of the heretofore-known devices and methods of this general type.

With the foregoing and other objects in view there is provided, in accordance with the invention, a leash, comprising:
a strap with an attachment device (e.g., snap hook, carabiner) at a bottom end thereof, for attaching to an animal's collar or harness;
a retaining loop at a top end of the strap; and
a handgrip disposed in the retaining loop or adjacent the retaining loop.

The retaining loop may be a prefabricated retaining loop and/or an adjustable retaining loop formed by engaging a snap hook in eyelets along the strap.

In other words, the novel leash, similarly to prior art leashes, comprises a strap or belt with a carabiner hook at a bottom end, for attaching to an animal using a collar or a harness, and a prefabricated retaining loop, and/or one which can be produced by engaging a carabiner hook in spaced-apart eyelets, at its top end. The leash according to the invention also has, in the retaining loop or directly in front of the latter, a dimensionally stable handgrip which makes it possible for a leash to be gripped and secured such that it cannot slip out between the fingers of a hand, with the result that even strong animals can be led securely using a leash equipped with such a handgrip.

According to a particularly preferred embodiment of the invention, the handgrip contains a buckle of a motor vehicle seat belt, which is secured on the leash and can be moved out of the handgrip. The closure part may be substantially the same length as the handgrip and be produced from metal and thus forming the rigid core of the handgrip.

In accordance with a particularly advantageous embodiment of the invention, the handgrip comprises the closure part and a sheath which is itself provided with a closure, by which it can be opened and closed over its length, for example with a touch-and-close fastener, with the result that the closure part is easily accessible and is just as easy to stow away again. This inventive leash thus ensures that it is always possible to carry along a seat belt without it being necessary to provide or carry along within the motor vehicle any further necessary components which, accordingly, also cannot be forgotten or left lying around.

Such a closure part advantageously has a locking section and a fastening section which has a through-passage, through which the strap or the belt of the leash extends, with the result that it can be adjusted in position on the leash or is secured in a certain position, for example by transverse seams in a doubled region of the leash, but can be moved into any desired angled position in relation to the leash.

It is also preferably possible for the closure part of the leash according to the invention to be formed in two parts and to comprise a base plate, with a through-passage for fastening the base plate on the leash, and the actual closure part, which is secured on the base plate via an articulation and, furthermore, is equipped with two different locking sections for different motor-vehicle seat belt locks, with the result that the application area of the leashes is further increased to a considerable extent.

In the case of a particularly advantageous embodiment of the invention, the carabiner hook is spaced apart from the closure part by a distance which corresponds to that of a motor-vehicle seat belt lock and the collar or harness of an animal sitting or lying on a seat, or an area provided for this purpose, in a motor vehicle, with the result that it is also possible, if desired, for the room for movement for an animal in a motor vehicle to be significantly reduced. It is also advantageously possible to adjust this distance via the graduated length of the leash, which can be produced by engaging the carabiner hook into different eyelets of the leash.

The leash may also be configured as a long leash or as a short leash, the retaining loop, in the latter case, being arranged directly behind the closure part, with the result that a person can guide his/her hand through the retaining loop and can then grip the handgrip, a dimensionally stable and ergonomic retaining device being produced as a result.

Other features which are considered as characteristic for the invention are set forth in the appended claims.

Although the invention is illustrated and described herein as embodied in a leash, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a perspective view showing a leash that is configured as a short leash with a prefabricated retaining loop;

FIG. 2 is a side view of a long leash with a variable, adjustable retaining loop;

FIG. 3 is a similar view of an entire length of the leash according to FIG. 2 in a reduced-scale illustration;

FIG. 4 is a similar view of the leash according to FIG. 3 with the seat belt function activated;

FIG. 5 is a perspective view of the grip end of the leash according to FIG. 1 with the sheath open; and

FIG. 6 is a perspective view showing an open sheath of a handgrip with a closure part having two different locking sections.

### DESCRIPTION OF THE PREFERRED EMBODIMENTS

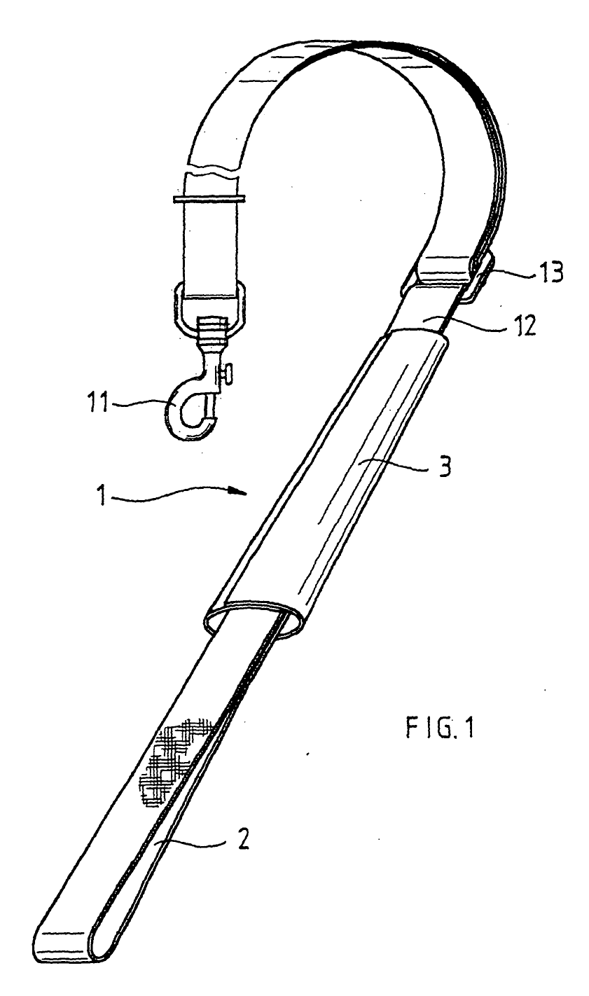

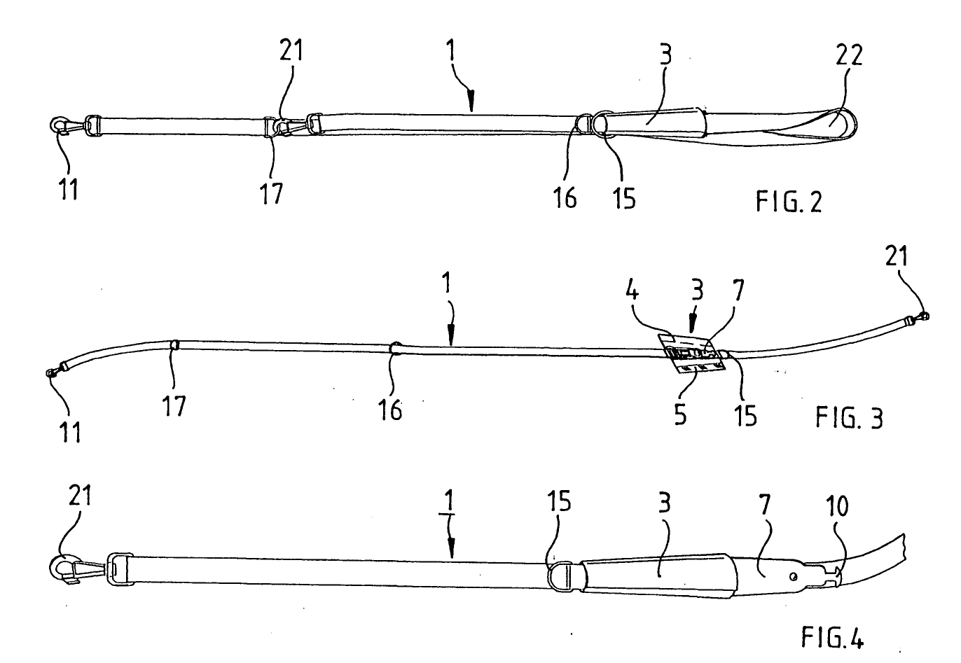

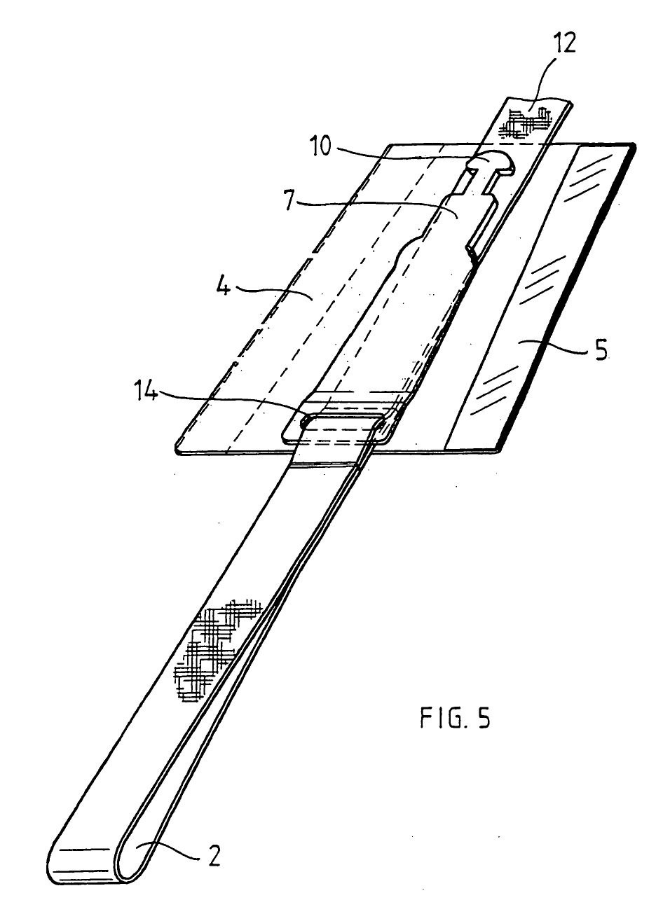

Referring now to the figures of the drawing in detail and first, particularly, to FIG. 1 thereof, there is shown a leash or lead 1 that comprises a strap 12 or belt, preferably made of leather or a braided plastic, and has, at the top end, either a prefabricated retaining loop 2 or a retaining loop 22 (cf. FIG. 2) which can be produced by engaging a snap hook or carabiner hook 21 in eyelets 15; 16; 17 of the leash 1. The leash 1 further has a snap hook or carabiner hook 11 at a bottom end, and also adjusting clasps 13, via which the length of the leash 1 can be adapted as desired. The snap hooks or carabiner hooks described and shown herein are but exemplary attachment devices and it will be understood that several equivalent attachment devices may be available.

The embodiment of the leash 1 which is illustrated in FIGS. 1 and 5 is designed as a short leash. In the region directly behind the retaining loop 2, it has a handgrip 3, which comprises a sheath 4 in which is formed a closure part 7 which has a through-passage 14, through which the strap or the belt of the leash 1 extends and is secured by transverse seams provided therein. Arranged at that end of the closure part 7 which is opposite to the through-passage 14 is a locking section 10 similar to a seat belt buckle. The locking section can be introduced into a large number of conventional motor vehicle seat belt buckle receivers.

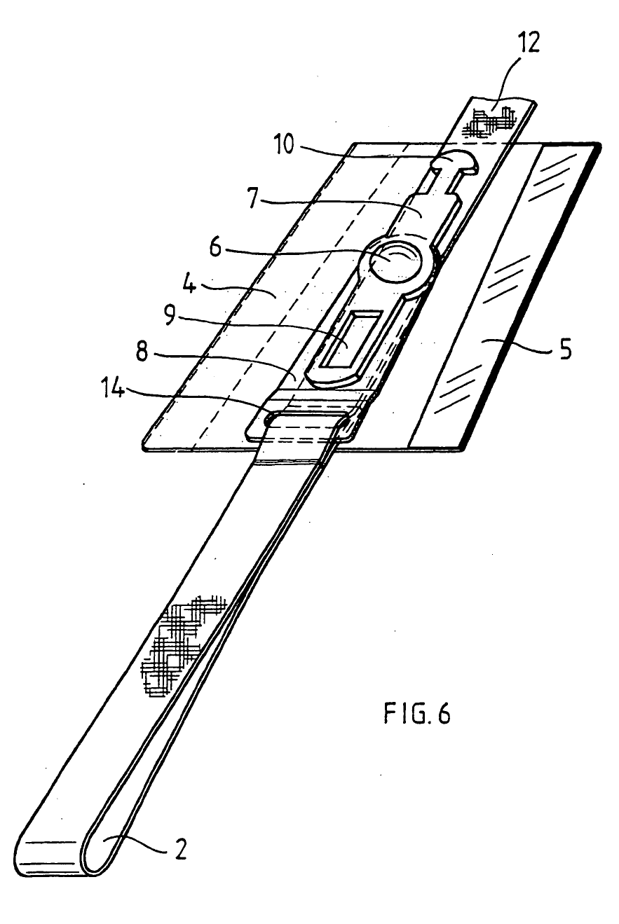

A closure part as is illustrated in FIG. 6 has a base plate 8, with a through-passage 14, and an articulation 6, via which two locking sections 9; 10 of the closure part 7 can optionally be rotated into an operational position, with the result that, with this type of closure part, it is possible to utilize all common seat belt locks for strapping an animal in a motor vehicle using a seat belt.

As is illustrated in FIG. 3, it is also possible for a leash 1 to be designed as long leash and to be provided with a second snap hook or carabiner hook 21 and with different eyelets 15; 16; 17 over the length of the leash 1, it being possible for an eyelet 15 to be disposed, for example, in front of the handgrip 3, for an eyelet to be spaced apart behind the handgrip 3 and for an eyelet 17 to be arranged in the end region of the leash 1, with the result that engaging the carabiner hook 21 into the first eyelet 15 gives a prefabricated retaining loop in a form similar to FIG. 1 and, for example, engaging the carabiner hook 21 into the last eyelet 17 of the leash 1 gives a vastly shortened leash 1 with a retaining loop 22 through which a hand can likewise be guided before the handgrip 3 is gripped, with the result that the user can choose the use position which is most comfortable or seems to be most expedient.

The sheath 4 of the handgrip 3 preferably has a hook-and-loop fastener 5, such as mating Velcro® strips. The fasteners 5 allow the sheath 4 to be easily fastened around the closure part 7 enclosing the rigid core of the handgrip 3 or the closure part 7 connected to the base plate 8.

1. A leash, comprising:
a strap with an attachment device at a bottom end thereof, for attaching to an animal's collar or harness;
a retaining loop at a top end of said strap; and
a handgrip disposed at or adjacent said retaining loop.

2. The leash according to claim 1, wherein said retaining loop is a prefabricated retaining loop.

3. The leash according to claim 1, wherein said retaining loop is an adjustable retaining loop formed by engaging a snap hook in eyelets along said strap.

4. The leash according to claim 1, wherein said attachment device is a carabiner hook or a snap hook.

5. The leash according to claim 1, wherein said handgrip contains a closure part with a buckle of a motor vehicle seat belt, and said closure part is secured on said strap.

6. The leash according to claim 5, wherein said handgrip includes a sheath enclosing said closure part and including a closure for selectively opening and closing said sheath lengthwise, said closure part and said sheath together forming said handgrip.

7. The leash according to claim 5, wherein said closure part is formed with a locking section and a fastening section having a through-passage for guiding said strap therethrough.

8. The leash according to claim 5, wherein said closure part is formed in two parts with a base plate, formed with a through-passage, and a buckle part, secured on said base plate via an articulation and having two different locking buckles for mutually different motor vehicle seat belt buckle receivers.

9. The leash according to claim 5, wherein said attachment device is spaced apart from said closure part by a distance corresponding to a distance between a motor vehicle seat belt buckle receiver a collar or harness of an animal sitting or lying in the motor vehicle.

10. The leash according to claim 9, wherein said strap is an adjustable length strap configured to enable adjusting the distance between said closure part and said attachment device.

11. The leash according to claim 1 configured as a short leash, wherein said retaining loop is disposed directly behind said closure part, and a dimensionally stable, ergonomic retaining device is formed for a person's hand guided through said retaining loop and by said handgrip, comprising a closure part and a sheath, gripped by the person's hand.
